(19) United States
(12) Patent Application Publication
(10) Pub. No.: US 2022/0355313 A1
(43) Pub. Date: Nov. 10, 2022

(54) MINERAL PROCESSING METHOD

(71) Applicants: KYUSHU UNIVERSITY, NATIONAL UNIVERSITY CORPORATION, Fukuoka-shi, Fukuoka (JP); SUMITOMO METAL MINING CO., LTD., Tokyo (JP)

(72) Inventors: Tsuyoshi HIRAJIMA, Tokyo (JP); Hajime MIKI, Fukuoka-shi (JP); Keiko SASAKI, Fukuoka-shi (JP); Gde Pandhe Wisnu SUYANTARA, Fukuoka-shi (JP); Yuki SEMOTO, Fukuoka-shi (JP); Shigeto KUROIWA, Tokyo (JP); Yuji AOKI, Tokyo (JP); Yoshiyuki TANAKA, Tokyo (JP)

(73) Assignees: KYUSHU UNIVERSITY, NATIONAL UNIVERSITY CORPORATION, Fukuoka-shi, Fukuoka (JP); SUMITOMO METAL MINING CO., LTD., Tokyo (JP)

(21) Appl. No.: 17/765,398

(22) PCT Filed: Nov. 13, 2020
(86) PCT No.: PCT/JP2020/042427

§ 371 Date: Mar. 30, 2022

(30) Foreign Application Priority Data
Nov. 25, 2019 (JP) 2019-212060
Nov. 11, 2020 (JP) 2020-187828

(51) Int. Cl. B03D 1/02; C22B 15/00

(52) U.S. Cl. CPC B03D 1/02; C22B 15/00; B03D 2203/02

(57) ABSTRACT

Provided is a mineral processing method that can efficiently separate a copper mineral and a molybdenum mineral. A mineral processing method includes a conditioning step of adding a disulfite to a mineral slurry containing a copper mineral and a molybdenum mineral and a flotation step of performing flotation using the mineral slurry after the conditioning step. By selectively enhancing hydrophilicity of the copper mineral with the disulfite, the hydrophilicity between the copper mineral and the molybdenum mineral can be differentiated. Thus, the molybdenum mineral can be selectively floated, and the copper mineral and the molybdenum mineral can be efficiently separated.

### TECHNICAL FIELD

The present invention relates to a mineral processing method. More specifically, the present invention relates to the mineral processing method for separating copper minerals from molybdenum minerals.

### BACKGROUND ART

In a field of copper smelting, various methods for recovering copper from raw materials such as copper ores and copper concentrates that contain copper have been proposed. For example, the following processings are performed to recover copper from the copper ores.

(1) Mineral Processing Step

In the mineral processing step, after grinding copper ores mined from a mine, water is added to form a slurry, and then flotation is performed. The flotation is performed by adding a flotation agent composed of a depressant, a frothing agent, a collector, and the like to the slurry, blowing air into the slurry to cause copper minerals to float and gangue to precipitate for separation. A copper concentrate with a copper grade of approximately 30% can be obtained.

(2) Pyrometallurgical Smelting Step

In the pyrometallurgical smelting step, the copper concentrate obtained in the mineral processing step melts by using a furnace such as a flash furnace, undergoes a converter and a refining furnace, and is refined up to crude copper with the copper grade of about 99%. The crude copper is cast into anodes used in an electrolysis step of the next step.

(3) Electrolysis Step

In the electrolysis step, the anodes are inserted into an electrolytic cell filled with a sulfuric acidic solution (electrolyte) and electric current is passed between the anodes and cathodes, thus performing an electrolytic refining. By the electrolytic refining, copper of the anodes is dissolved and is deposited on the cathodes as electrolytic copper with a purity of 99.99%.

Meanwhile, copper is often present in a copper sulfide ore as a sulfide mineral, such as chalcopyrite and bornite. In a mine having a copper deposit called a porphyry type, chalcopyrite and bornite in the ore are accompanied with molybdenite.

Molybdenum contained in molybdenite is a valuable element used for, for example, an alloy component of special steel, a. catalyst for petroleum refining, and a lubricant. When molybdenite melts in a furnace, volatilized molybdenum adheres to an apparatus and accelerates corrosion. Thus, it is required to separate the copper minerals from the molybdenum minerals in the mineral processing.

The separation of the copper minerals from the molybdenum minerals is often performed by the flotation because industrial handleability, cost, and separability are excellent. The flotation suppresses the copper minerals from floating up by adding a sulfidizing agent, such as a sodium hydrosulfide (NaHS), as the depressant and causes the molybdenum minerals to float up to separate these. However, the flotation using the sodium hydrosulfide is difficult to set mineral processing conditions. When a mineral slurry shows acidity, hydrogen sulfide, which is a harmful gas, is generated from the slurry where the sodium hydrosulfide is added.

Both the copper minerals and molybdenum minerals have high floatability, and thus, it is very difficult to separate these by the flotation. Therefore, it has been attempted to facilitate the separation by performing the flotation after executing a treatment to these minerals.

Patent Literature 1 discloses a method that performs the flotation after oxidizing a surface of a mineral by ozone. More specifically, molybdenum flotation is performed on the copper concentrate obtained by copper roughening and copper selection. At a time point when a content of molybdenite of an obtained floating ore becomes approximately 1 weight %, the floating ore is oxidized by ozone. The floating ore is subjected to the flotation again and the molybdenum minerals is recovered as the floating ore.

Patent Literature 2 discloses a method that performs flotation after performing a plasma treatment to surface of minerals. More specifically, plasma irradiation is performed on a mixture of minerals containing copper and minerals containing molybdenum under atmosphere with oxygen as an oxidizing agent. The mixture after the plasma treatment is cleaned with an aqueous solution of alkali metal salt. The mixture after the cleaning is subjected to the flotation, and the minerals containing copper are separated from the minerals containing molybdenum.

Patent Literature 3 discloses that performing surface treatment on a concentrate by an oxidizing agent that does not generate a harmful ion in pulp (slurry) due to a reaction, for example, hydrogen peroxide and ozone, and other reagents, and refining them preferentially separate a target component.

### CITATION LIST

### Patent Literature

Patent Literature 1: JP-A-5-195106

Patent Literature 2: JP-A-2014-188428

Patent Literature 3: JP-B-45-016322

### SUMMARY OF INVENTION

### Technical Problem

However, in the method of Patent Literature 1, sulfur in the minerals is also oxidized by ozone, and sulfur dioxide is generated. Under an acidic condition, it is likely that hydrogen sulfide is generated. Since a mineral slurry shows acidity, some copper dissolves and copper is likely to be drained with drainage.

In the method of Patent Literature 2, while plasma treatment is required, a large-sized plasma irradiation apparatus is unknown. Thus, it is difficult to execute in an industrial scale.

In Patent Literature 3, only action of an oxidizing agent relative to galena (lead mineral) that has absorbed a collector on its surface is described, and nothing is described on oxidization of a copper mineral and a molybdenum mineral.

In view of circumstances described above, it is an object of the present invention to provide a mineral processing method that allows efficient separation of the copper mineral from the molybdenum mineral.

### Solution to Problem

The mineral processing method of a 1st invention includes: a conditioning step of adding a disulfite to a mineral slurry containing a copper mineral and a molybdenum mineral; and a flotation step of performing flotation using the mineral slurry after the conditioning step.

In the mineral processing method of a 2nd invention, in the 1st invention, the mineral slurry is obtained by mixing a mineral and seawater, and a pH of a liquid phase of the mineral slurry is 4 to 6.

In the mineral processing method of a 3rd invention, in the 1st or 2nd invention, the disulfite is a sodium disulfite or a potassium disulfite.

In the mineral processing method of a 4th invention, in the 1st or 2nd invention, in the conditioning step, the sodium disulfite is used as the disulfite, and an addition amount of the sodium disulfite is set to 5 to 25 kg/t relative to mineral weight of the mineral slurry.

In the mineral processing method of 5th invention, in any one of the 1st to 4th invention, the copper mineral includes one or more kinds selected from the group consisting of chalcopyrite, bornite, enargite, chalcocite, tennantite, and covellite, and the molybdenum mineral is molybdenite.

### Advantageous Effects of Invention

According to the present invention, by selectively enhancing hydrophilicity of the copper mineral by a disulfite, the hydrophilicity between the copper mineral and the molybdenum mineral can be differentiated. Thus, the molybdenum mineral can be selectively floated up, and the copper mineral can be efficiently separated from the molybdenum mineral.

### BRIEF DESCRIPTION OF DRAWINGS

FIG. 1 is a process diagram of a mineral processing method according to one embodiment of the present invention.

FIG. 2 is a front view of a column flotation machine.

### DESCRIPTION OF EMBODIMENTS

Next, the embodiment of the present invention will be described based on the drawings.

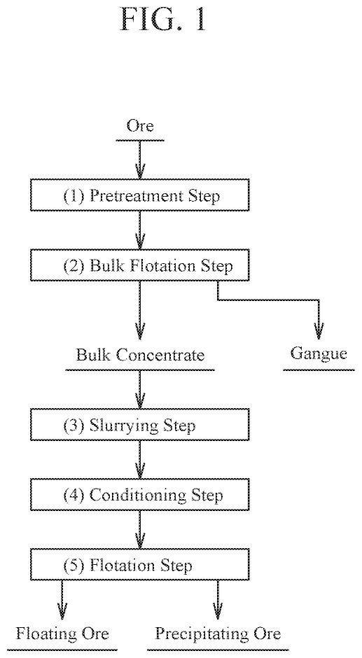

As illustrated in FIG. 1, the mineral processing method according to the one embodiment of the present invention includes (1) a pretreatment step, (2) a bulk flotation step, (3) a slurrying step, (4) a conditioning step, and (5) a flotation step. It is only necessary that the mineral processing method according to the embodiment includes at least (4) the conditioning step and (5) the flotation step, and other processes may be omitted or added.

It is only necessary that an ore as a raw material includes at least a mineral containing copper (hereinafter referred to as “a copper mineral”) and a mineral containing molybdenum (hereinafter referred to as “a molybdenum mineral”). As the copper mineral, for example, chalcopyrite (CuFeS₂), bornite (Cu₅FeS₄), enargite (Cu₃AsS₄), chalcocite (Cu₂S), tennantite ((Cu, Fe, Zn)₁₂(Sb, As)₄S₁₃), and covellite (CuS) are includes. As the molybdenum mineral, for example, molybdenite (MoS₂) is included.

The mineral processing method of the embodiment is suitably used for separation of the copper mineral and the molybdenum mineral. In a mine with a copper deposit called a porphyry type, chalcopyrite and bornite in an ore is accompanied with molybdenite. Thus, the mineral processing method of the embodiment is suitably used for the ore mined from the copper deposit of the porphyry type.

(1) Pretreatment Step

In the pretreatment step, for example, grinding of an ore and removal of a gangue are performed.

The ore is ground to obtain mineral particles. The particle sizes of the mineral particles are adjusted so as to obtain individual minerals, according to the size of the mineral contained in the ore. For example, in the case of chalcopyrite, it is generally adjusted to under about 100 μm sieve, and in the case of molybdenite, it is generally adjusted to under about 30 μm sieve. In an actual operation using the ores containing various kinds of minerals as the raw material, after grinding to under about 100 μm sieve, it is general to adjust the particle size of the ore to the optimum conditions, in consideration of the flotation results.

When, after the grinding, the mineral particles are stored for a long period, the surface state of the mineral sometimes changes due to, for example, an adhered substance. In this case, it is preferable that the adhered substance on the surface of the mineral is removed prior to charging the mineral particles into the next process. A removal method of the adhered substance is not specifically limited, and, for example, nitric acid cleaning and frictional pulverization (attrition), are included.

As necessary, it is preferable to remove the gangue contained in the ore. Various kinds of mineral processing methods such as the flotation can be employed for removing the gangue.

(2) Bulk Flotation Step

Water is added to the mineral particles (the ground ore) to produce a mineral slurry. In the bulk flotation step, a sulfide mineral contained in the mineral slurry and the other gangues are separated by the flotation. In the bulk flotation, a flotation reagent composed of, for example, a frothing agent and a collector is added to the mineral slurry, and the gangue to precipitate for separation while blowing air to collectively float various kinds of sulfide minerals. As the frothing agent, for example, a pine oil, and methyl isobutyl carbinol (MIBC) are included. As the collector, for example, a diesel oil, a kerosene oil, a mercaptan-based collector, and a thionocarbamate-based collector are included.

When the diesel oil or the kerosene oil is used as the collector, while the collector may be added directly to the mineral slurry, it is preferable that the collector is added to the mineral slurry after the collector is emulsified. For emulsification of the collector, a general emulsification device such as a high-speed blender, an ultrasonic emulsifier, and a stirring emulsifier can be used. A commercially available emulsifier (for example, Span 80, Tween 80) may be used. It is only necessary that the emulsifier is directly added to and mixed with the collector, or the emulsifier dispersed in water is added to and mixed with the collector. When the emulsifier is dispersed in water, it is preferable to add an appropriate amount of NaCl in the water and warm it to about 45° C. Then, the emulsifier is easily dissolved in the water.

The sulfide mineral obtained by the bulk flotation is referred to as a bulk concentrate. In the bulk concentrate, the copper mineral and the molybdenum mineral are at least included. It is preferable that, as the copper minerals, the bulk concentrate includes one or more kinds selected from the group consisting of chalcopyrite, bornite, enargite, chalcocite, termantite, and covellite. It is preferable that the bulk concentrate includes molybdenite as the molybdenum mineral.

When the ore mined from the copper deposit of the porphyry type is used as a raw material, a mineral ratio of the bulk concentrate and the grades of copper and molybdenum are shown in Table 1. Here, the mineral ratio is a result obtained by a Mineral Liberation Analyzer (MLA) analysis, and the grades of copper and molybdenum are obtained by a chemical analysis. The MLA is a mineral analyzer based on a scanning electron microscope with an energy dispersive X-ray analyzer.

TABLE 1
(Unit: weight %)

| Chalcopyrite | Bornite | Chalcocite | Molybdenite | Cu Grade | Mo Grade |
|---|---|---|---|---|---|
| 50 to 60 | 1 to 3 | 7.0 or less | 1 to 11 | 20 to 30 | 6 or less |

As can be seen from Table 1, in the bulk concentrate, the copper mineral and the molybdenum mineral are included. The copper mineral is a mixed copper sulfide mineral including chalcopyrite as a main component, bornite and chalcocite. The molybdenum mineral is molybdenite. The bulk concentrate undergoes ore polishing processing as necessary, and, for example, impurities and oxides are removed from the surface of concentrate particles.

(3) Slurrying Step

The bulk concentrate and water is mixed to obtain the mineral slurry. As the water used for producing the mineral slurry, for example, pure water where no impurities are contained, ion-exchanged water, and seawater can be used. However, magnesium and calcium are contained in seawater. When a liquid phase of the mineral slurry becomes alkaline, Mg(OH)₂ and CaCO₃ are deposited on the surfaces of the mineral particles. Due to this, a separation efficiency between the copper mineral and the molybdenum mineral is likely to be decreased in the flotation of a subsequent process.

Therefore, when seawater is used for producing the mineral slurry, it is preferable that the liquid phase of the mineral slurry is maintained to be neutral or acidic. For example, it is preferable that a pH of the liquid phase of the mineral slurry is adjusted to 4 to 6. Then, the deposit of magnesium and calcium can be suppressed.

While a pH regulator is not specifically limited, as alkali, for example, sodium hydroxide (NaOH), potassium hydroxide (KOH), calcium hydroxide (Ca(OH)₂), and calcium carbonate (CaCO₃) can be used. As acid, for example, sulfuric acid (H₂SO₄) and hydrochloric acid (HCl) can be used. When the pH regulator is used in a form of an aqueous solution, its concentration is not specifically limited, and it is only necessary that it is not difficult to adjust the mineral slurry to a target pH with its concentration.

(4) Conditioning Step

In the conditioning step, a surface treatment agent is added to the mineral slurry containing the copper mineral and the molybdenum mineral. As the surface treatment agent, a disunite is used. As the disulfite, a sodium disunite (Na₂S₂O₅) and a potassium disulfite (K₂S₂O₅) are included. Among these, the sodium disulfite is preferable because it is easily available.

When the sodium disunite is used as the surface treatment agent, it is preferable that an addition amount of the surface treatment agent is set to 5 to 25 kg/t relative to a mineral weight of the mineral slurry. Then, in the flotation in the next process, the copper mineral and the molybdenum mineral can be efficiently separated.

The disulfite can be used as the flotation reagent even in the bulk flotation. When the bulk flotation and the flotation in the next process are continuously performed, it is preferable that the addition amount of the disunite in this process is determined in consideration of the addition amount of the disulfite added to the mineral slurry in the bulk flotation step.

When the flotation in the next process is performed in multiple stages, the disulfite may be added collectively at a first stage, or it may be added by being divided into a plurality of times.

By adding the disulfite in the mineral slurry, hydrophilicity of the copper mineral can be selectively enhanced, and the hydrophilicity between the copper mineral and the molybdenum mineral can be differentiated. Thus, in the flotation step in the next process, the molybdenum mineral can be selectively floated, and the copper mineral and the molybdenum mineral can be efficiently separated.

In addition to the disulfite, the flotation reagent may be added to the mineral slurry. As the flotation reagent, for example, an oxidizing agent oxidizing the surfaces of the mineral particles, the collector decreasing the hydrophilicity of the surfaces of the mineral particles, a depressant improving the hydrophilicity of the surfaces of the mineral particles, and the frothing agent causing air bubble to be easily generated during the flotation are included. As the collector, for example, a diesel oil, a kerosene oil, a mercaptan-based collector, and a thionocarbamate-based collector are included. As the frothing agent, for example, a pine oil, and MIBC (methyl isobutyl carbinol) are included.

However, potassium amyl xanthate (PAX) known as the collector is likely to inhibit a suppressing effect of the disulfite.

When the diesel oil or the kerosene oil is used as the collector, while the collector may be added directly to the mineral slurry, it is preferable that the collector is added to the mineral slurry after the collector is emulsified. For the emulsification of the collector, the general emulsification device such as the high-speed blender, the ultrasonic emulsifier, and the stirring emulsifier can be used. A commercially available emulsifier (for example, Span 80, Tween 80) may be used. It is only necessary that the emulsifier is directly added to and mixed with the collector, or the emulsifier dispersed in water is added to and mixed with the collector. When the emulsifier is dispersed in water, it is preferable to add an appropriate amount of NaCl in the water and warm it to about 45° C. Then, the emulsifier is easily dissolved in the water.

When the surfaces of the mineral particles are in a fresh, unoxidized state, for example, immediately after grinding of the ore (for example, when a pure mineral is ground under nitrogen atmosphere), or immediately after ore polishing of the bulk concentrate, it is preferable that the mineral slurry after the disulfite is added undergoes aeration with a small amount of air to the extent that does not generate froth. Then, ferric oxides and copper oxides (for example, FeO, Fe₂O₃, FeOOH, CuO, Cu₂O) that cannot be removed by the disulfite are generated on the surface of the copper mineral. Since the copper mineral is oxidized and hydrophilized to some extent, the hydrophilicity between the copper mineral and the molybdenum mineral can also be differentiated with this.

When the surface of the copper mineral has already oxidized, it is not recognized that the aeration has a so large effect. While there are many unclear points for this cause, it is considered that the ferric oxide and the copper oxide are already generated on the surface of the copper mineral, and thus, oxygen supplied by the aeration is less likely to contribute to oxidization of the copper mineral. During stirring of the mineral slurry in the conditioning step, a small amount of oxygen dissolves into water, and oxygen is also supplied by introduction of air in the flotation. Thus, it is considered that oxygen is sufficiently supplied to the copper mineral even without performing the aeration.

(5) Flotation Step

In the flotation step, the flotation is performed using the mineral slurry after conditioning. By the flotation, the molybdenum mineral is separated as a floating ore and the copper mineral is separated as a precipitating ore. More precisely, a raw material mineral included in the mineral slurry is separated into the floating ore with a molybdenum mineral ratio higher than that of the raw material mineral and the precipitating ore with a copper mineral ratio higher than that of the raw material mineral. The device and the system used for the flotation is not specifically limited, and it is only necessary to use a general multi-stage flotation apparatus.

In the flotation, as a gas blown to the mineral slurry, various kinds of gasses can be used. For example, when economic efficiency is prioritized, atmosphere (air) is used. To reduce a change in a degree of oxidation of the mineral particles, a gas that does not include oxygen, for example, nitrogen is used. On the contrary, in causing the oxidation of the mineral particles to accelerate, oxygen is used. In sulfurizing the mineral particles, a sulfurous acid gas is used.

When the surfaces of the mineral particles are contaminated with oxides or impurities, the frictional pulverization (attrition), or the ore polishing is sometimes performed prior to the flotation. When the mineral particles are aggregated, shear agitation is sometimes performed. In such case, to make the surfaces of the mineral particles an appropriate oxidation state, it is preferable that atmosphere (air) or oxygen is blown to the mineral slurry in the flotation. The oxidizing agent such as a hydrogen peroxide solution may be added to the mineral slurry. Both the blowing of atmosphere (air) or oxygen and addition of the oxidizing agent may be performed while adjusting a balance. In this case, the pH of the liquid phase of the mineral slurry decreases, and thus, it is preferable to perform pH adjustment as necessary while monitoring the pH.

As described above, by adding the disulfite to the mineral slurry, the hydrophilicity between the copper mineral and the molybdenum mineral can be differentiated. Thus, while precipitating the copper mineral, the molybdenum mineral can be selectively floated. Consequently, the copper mineral and the molybdenum mineral can be efficiently separated.

While the reason the hydrophilicity between the copper mineral and the molybdenum mineral is differentiated by the addition of the disulfite is not necessarily apparent, it is presumed as follows. The disulfite acts as a reductant in an aqueous solution. Thus, when the disulfite is added to the mineral slurry, the copper mineral is reduced. For example, chalcopyrite, bornite, and covellite are reduced by the following reactions.

The reduction of chalcopyrite: CuFeS₂+3Cu²⁺+3e⁻=2Cu₂S+Fe³⁺ (1)

The reduction of bornite: Cu₅FeS₄+3Cu²⁺+3e⁻=4Cu₂S+Fe³⁺ (2)

The reduction of covellite: CuS+Cu²⁺+2e⁻=Cu₂S (3)

The chalcocite (Cu₂S) generated by these reactions is easily oxidized compared to chalcopyrite, bornite, and covellite. When chalcocite is oxidized, Cu²⁺ ions are generated. Fe³⁺ ion generated by the reduction of chalcopyrite and bornite, and Cu²⁺ ion generated by the oxidation of chalcocite generate, for example, a hydroxide, an oxyhydroxide and the oxide of iron and copper on the mineral surface. Since these have hydrophilicity, the copper mineral is hydrophilized.

On the other hand, in the molybdenum mineral, the above reaction does not occur. The molybdenum mineral keeps hydrophobicity. Consequently, the hydrophilicity between the copper mineral and the molybdenum mineral is differentiated.

As described above, when seawater is used for producing the mineral slurry, it is preferable that the pH of the liquid phase is adjusted to 4 to 6. Even when the pH of the liquid phase is adjusted to 4 to 6, the action of the disulfite as the surface treatment agent (the depressant of the copper mineral) is not inhibited. When the pH of the liquid phase is set to an acidic region of less than 4, the sulfurous acid gas (SO₂) is sometimes generated, which is preferably avoided.

There is known a sulfite and a hydrogen sulfite as the depressant suppressing floating of the copper mineral. The appropriate pH where the sulfite and the hydrogen sulfite act as the depressant is equal to or more than 8. When seawater is used for producing the mineral slurry, in a case where the pH is set to equal to or more than 8, magnesium and calcium included in seawater deposit on the surfaces of the mineral particles. Consequently, the action of the sulfite and the hydrogen sulfite as the depressant is inhibited, and the separation efficiency between the copper mineral and the molybdenum mineral is decreased.

When the hydrogen sulfite is added to the mineral slurry, a liquid property tends to be acidic. To adjust this to be equal to or more than pH 8, it is necessary to add a lot of alkalis. By an influence of the added alkalis, the separation efficiency is also likely to be decreased.

In contrast to this, when the disulfite is used as the depressant, even when the pH of the liquid phase of the mineral slurry is adjusted to 4 to 6, the copper mineral is inhibited, and the molybdenum mineral is not inhibited. Rather, the Ca²⁺ ion included in seawater reacts with the disulfide to generate, for example, CaSO₃, which is hydrophilicity, on the surface of the copper mineral. Consequently, it seems that the copper mineral can be made more hydrophilic.

Thus, when the disunite is used as the depressant, even when seawater is used for producing the mineral slurry, the copper mineral and the molybdenum mineral can be efficiently separated.

### EXAMPLES

Next, Examples are described.

### Example 1

The chalcopyrite and the molybdenite, which are commercially available pure minerals, are prepared. The chalcopyrite and the molybdenite were each ground in an agate mortar to be a size of under 38 μm sieve. The chalcopyrite and the molybdenite were mixed at a weight ratio of 1:1 to obtain a concentrate.

By adding 180 mL of ultrapure water to 0.6 g of the concentrate and stirring it with a magnetic stirrer for two minutes, the mineral slurry was obtained. The mineral slurry has a solid content concentration of approximately 0.3 weight %. The sodium disunite as the depressant and the pine oil as the frothing agent were added to the mineral slurry, and it was stirred by the magnetic stirrer for five minutes. Here, the addition amount of the sodium disulfite was set to 22.3 kg/t relative to a concentrate weight. The addition amount of the pine oil was set to 31.5 kg/t relative to the concentrate weight. The pH of the liquid phase of the mineral slurry was 5, and no pH adjustment was performed.

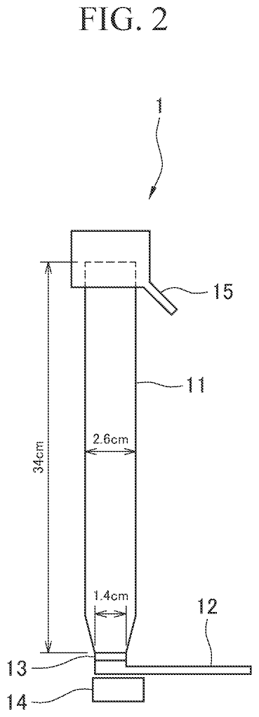

The mineral slurry was charged into a. column flotation machine 1 to perform the flotation. FIG. 2 illustrates the column flotation machine 1, which was used. The column flotation machine 1 has a cylindrical column 11 having a height of 34 cm and a diameter of 2.6 cm. A blowing pipe 12 having a diameter of 0.5 cm is connected to a lower portion of the column 11. A gas introduced from the blowing pipe 12 passes through a glass filter 13 (a pore diameter 10 μm to 30 μm) and is supplied inside the column 11. A rotator of a magnetic stirrer 14 is arranged on the glass filter 13. By stirring and shearing of the rotator, the gas becomes air bubbles. The air bubbles where the floating ore adheres overflows from an upper end of the column and are discharged from a discharge pipe 15. The precipitating ore precipitates on the glass filter 13.

Nitrogen was used as the gas to be introduced from the blowing pipe 12. A supply amount of the gas was set to 20 mL/minute. The floating ore was recovered at time points of one minute, two minutes, four minutes, and six minutes from a start of the flotation. After drying the floating ores at the respective time points, the weight of the floating ore were calculated by weighing and totaling. The grades of copper and molybdenum contained in the concentrate and the floating ore were measured by the chemical analysis. Newton efficiency obtained from the measurement results was 48.7%.

The Newton efficiency was determined by the following procedure. Let A(Cu) be the weight of copper contained in the concentrate supplied to the flotation, and let A(Mo) be the weight of molybdenum contained in the concentrate supplied to the flotation. Let B(Cu) be the weight of copper contained in the recovered floating ore, and let B(Mo) be the weight of molybdenum contained in the recovered floating ore. A copper recovery rate is obtained by Formula (4). A molybdenum recovery rate is obtained by Formula (5). According to Formula (6), the Newton efficiency is determined from the copper recovery rate and the molybdenum recovery rate.

The copper recovery rate [%]=(B(Cu)/A(Cu))×100 (4)

The molybdenum recovery rate [%]=(B(Mo)/A(Mo)×100 (5)

The Newton efficiency [%]=[the molybdenum recovery rate]−[the copper recovery rate] (6)

### Comparative Example 1

The mineral slurry was produced, and the flotation was performed, by the same procedure and conditions as Example 1. However, the sodium disulfite was not added to the mineral stuffy. Consequently, the Newton efficiency was 36.6%.

In Example 1, the Newton efficiency is higher compared to the Comparative Example 1. Thus, it is confirmed that, by adding the sodium disulfite to the mineral slurry, the copper mineral and the molybdenum mineral can be efficiently separated.

### Example 2

The mineral slurry was produced, and the flotation was performed, by the same procedure and conditions as Example 1. However, artificial seawater was used for producing the mineral slurry. The composition of the artificial seawater is shown in Table 2. Consequently, the Newton efficiency was 55.3%.

TABLE 2
(Unit: g/L)

| Cl⁻ | Na⁺ | SO₄²⁻ | Mg²⁺ | Ca²⁺ | K⁺ | HCO₃⁻ | Br⁻ |
|---|---|---|---|---|---|---|---|
| 17.87 | 10.01 | 2.64 | 1.18 | 0.41 | 0.35 | 0.14 | 0.06 |

### Comparative Example 2

The mineral slurry was produced, and the flotation was performed, by the same procedure and conditions as Example 2. However, the sodium disulfite was not added to the mineral slurry. Consequently, the Newton efficiency was 15.9%.

The Newton efficiency in Example 2 is higher compared to that in Comparative Example 2. Thus, even when the mineral slurry is produced using seawater, it is confirmed that, by adding the sodium disulfite to the mineral slurry, the copper mineral and the molybdenum mineral can be efficiently separated.

When Comparative Example 1 and Comparative Example 2 are compared, the Newton efficiency in the Comparative Example 2 where the mineral slurry was produced using seawater is lower. Thus, in general, it can be said that use of seawater is not preferable for the separation of the copper mineral and the molybdenum mineral. However, when Example 1 and Example 2 are compared, the Newton efficiency in Example 2 where the mineral slurry was produced using seawater is higher. When the disulfite is used as the depressant, it was confirmed that the copper mineral and the molybdenum mineral can be separated more efficiently by producing the mineral slurry using seawater.

### Example 3

A bulk concentrate obtained from an actual ore was prepared. The mineral ratio of the bulk concentrate and the grades of copper and molybdenum are shown in Table 3. Here, the mineral ratio is a result obtained by the MLA analysis, and the grades of copper and molybdenum are results obtained by the chemical analysis.

TABLE 3
(Unit: weight %)

| Chalcopyrite | Bornite | Chalcocite | Molybdenite | Cu Grade | Mo Grade |
|---|---|---|---|---|---|
| 51.0 | 3.0 | 4.2 | 8.6 | 22 | 4.5 |

After adding 370 mL of ultrapure water to 225 g of the bulk concentrate and charging it into a fahrenwald type flotation machine, stirring was performed for one minute as a shear agitation operation. Subsequently, after adding the sodium disulfite to the mineral slurry as the depressant and stirring it for two minutes, the shear agitation was performed for 57 minutes while the gas was further supplied. Subsequently, after further adding 300 mL of ultrapure water (total addition amount 670 mL of ultrapure water) and stirring it for two minutes by the fahrenwald type flotation machine, the mineral slurry was obtained. The solid content concentration of the mineral slurry is approximately 25 weight %. After adding the emulsified kerosene to the mineral slurry as the collector and stirring it for three minutes, the pine oil was added as the frothing agent and stirring was further performed for two minutes by the fahrenwald type flotation machine. Here the addition amount of the sodium disunite was set to 7.5 kg/t relative to the concentrate weight. The addition amount of the emulsified kerosene was set to 90 g/t relative to the concentrate weight. The addition amount of the pine oil was set to 53 g/t relative to the concentrate weight. The pH of liquid phase of the mineral slurry was 5.7, and the pH adjustment was not performed.

The flotation was performed with the fahrenwald type flotation machine. Oxygen was used as a gas to be introduced in the flotation machine. The supply amount of the gas was set to 3 L/minute. A flotation time was set to 20 minutes. After drying the recovered floating ore, the weight was measured. The grades of copper and molybdenum contained in the floating ore was measured by the chemical analysis. The Newton efficiency determined from the measurement result was 70.6%.

### Example 4

The mineral slurry was produced, and the flotation was performed, by the same procedure and conditions as Example 3. However, the artificial seawater was used for producing the mineral slurry. Consequently, the Newton efficiency was 75.5%.

From Examples 3 and 4, it was confirmed that even when the flotation of the bulk concentrate obtained from the actual ore was performed, the copper mineral and the molybdenum mineral were able to be efficiently separated by adding the disulfite to the mineral slurry. It was confirmed that the Newton efficiency in Example 4 where the mineral slurry was produced using seawater was higher than that in Example 3 where the mineral slurry was produced using ultrapure water.

### Example 5

The mineral slurry was produced, and the flotation was performed, by the same procedure and conditions as Example 3. However, air was used as a gas to be introduced in the flotation machine. A flow rate of air was set to 2 L/minute. Consequently, the Newton efficiency was 81.6%.

### Example 6

The mineral slurry was produced, and the flotation was performed, by the same procedure and conditions as Example 3. However, the artificial seawater was used for producing the mineral slurry, and air was used as a gas to be introduced in the flotation machine. The flow rate of air was set to 2 L/minute. Consequently, the Newton efficiency was 85.3%.

When Examples 3 to 6 are compared, it can be seen that the Newton efficiency in using air as a gas to be introduced to the flotation machine is higher than that in using oxygen.

### Comparative Example 3

The mineral slurry was produced, and the flotation was performed, by the same procedure and conditions as Example 6. However, the sodium sulfite (Na₂SO₃) was added to the mineral shiny as the depressant, instead of the sodium disulfite. The addition amount of the depressant was set to 5.7 kg/t relative to the concentrate weight so as to become the same as a molar concentration (13.4 mM) of the addition amount of the depressant in Example 6. Consequently, the Newton efficiency was 48.5%.

It is known that, when the sodium sulfite is used as the depressant, the pH is preferably set to equal to or more than 8. The pH was 6.2 in Comparative Example 3, and it is considered that the sodium sulfite has not sufficiently acted as the depressant. Thus, the Newton efficiency has become a low value.

As described above, when seawater is used for producing the slurry, it is preferable that the liquid phase of the mineral slurry is maintained to be neutral or acidic. Under such conditions, to separate the copper mineral and the molybdenum mineral by the flotation, the separation efficiency becomes better when the disunite is used than when the sulfite is used, as the depressant.

The above results are summarized in Table 4.

TABLE 4

| | | | Depressant | Cu | Mo | |
|---|---|---|---|---|---|---|
| | | | Addition | Recovery | Recovery | Newton |
| | Slurry | | Amount | Rate | Rate | Efficiency |
| | Water | pH | [kg/t] | [%] | [%] | [%] |
| Example 1 | UPW | 5 | 22.3 | 31.0 | 79.7 | 48.7 |
| Comparative | UPW | 5 | 0 | 38.0 | 74.6 | 36.6 |
| Example 1 | | | | | | |
| Example 2 | SW | 5 | 22.3 | 12.9 | 68.2 | 55.3 |
| Comparative | SW | 5 | 0 | 64.0 | 79.9 | 15.9 |
| Example 2 | | | | | | |
| Example 3 | UPW | 5.7 | 7.5 | 6.3 | 76.9 | 70.6 |
| Example 4 | SW | 5.6 | 7.5 | 10.2 | 85.7 | 75.5 |
| Example 5 | UPW | 5.5 | 7.5 | 7.8 | 89.4 | 81.6 |
| Example 6 | SW | 5.9 | 7.5 | 8.4 | 93.7 | 85.3 |
| Comparative | SW | 6.2 | 5.7 | 49.8 | 98.3 | 48.5 |
| Example 3 | | | | | | |

*UPW: Ultrapure Water, SW: Artificial Seawater

### REFERENCE SIGNS LIST

1 column flotation machine

11 column

12 blowing pipe

13 glass filter

14 magnetic stirrer

15 discharge pipe

1. A mineral processing method comprising:
a conditioning step of adding a disulfite to a mineral slurry containing a copper mineral and a molybdenum mineral; and
a flotation step of performing flotation using the mineral slurry after the conditioning step so that a raw material mineral included in the mineral slurry is separated into a floating ore having a weight percent of the molybdenum mineral higher than a weight percent of the molybdenum material in the raw material mineral and a precipitating ore having a weight percent of the copper mineral higher than a weight percent of the copper material in the raw material mineral, wherein
the mineral slurry is obtained by mixing a mineral and seawater, and
a pH of a liquid phase of the mineral slurry is 4 to 6.

2. (canceled)

3. The mineral processing method according to claim 1, wherein
the disulfite is a sodium disulfite or a potassium disulfite.

4. The mineral processing method according to claim 1, wherein
in the conditioning step, a sodium disulfite is used as the disulfite, and an addition amount of the sodium disulfite is set to 5 to 25 kg/t relative to mineral weight of the mineral slurry.

5. The mineral processing method according to claim 1, wherein
the copper mineral includes one or more kinds selected from the group consisting of chalcopyrite, bornite, enargite, chalcocite, tennantite, and covellite, and
the molybdenum mineral is molybdenite.

6. The mineral processing method according to claim 3, wherein
the copper mineral includes one or more kinds selected from the group consisting of chalcopyrite, bornite, enargite, chalcocite, tennantite, and covellite, and
the molybdenum mineral is molybdenite.

7. The mineral processing method according to claim 4, wherein
the copper mineral includes one or more kinds selected from the group consisting of chalcopyrite, bornite, enargite, chalcocite, tennantite, and covellite, and
the molybdenum mineral is molybdenite.
